(19) United States
(12) Patent Application Publication
(10) Pub. No.: US 2007/0069432 A1
(43) Pub. Date: Mar. 29, 2007

(54) PLATEN FOR USE IN PRODUCT ENCAPSULATION

(76) Inventor: Frank Matich, Bayview, New South Wales (AU)

Correspondence Address: DAVID A. GUERRA;INTERNATION PATENT GROUP, LLC, 2025 17TH AVENUE N.W., CALGARY, AB, T2M 0S7, CA

(21) Appl. No.: 10/595,889

(22) PCT Filed: Dec. 8, 2004
(86) PCT No.: PCT/AU04/01731

§ 371 Date: May 18, 2006

(30) Foreign Application Priority Data
Dec. 19, 2003 (AU) 2003907074

(51) Int. Cl. B29C 53/02; B29C 55/00

(52) U.S. Cl. 264/553; 425/812; 425/388

(57) ABSTRACT

A platen (1) which can be quickly evacuated and used in product encapsulation and like processes is provided where the platen (1) is configured to be gaseously evacuated. The platen (1) comprises a base plate (2), at least one gas evacuation conduit (11) configured to communicate through the base plate (2), and a support plate (3) spaced apart from the base plate (2) to create a plenum chamber (9) between the base plate (2) and the support plate (3) where each gas evacuation conduit (11) is in communication with the plenum chamber (9). The platen (1) further comprises a first array of channels (14) formed in the surface of the support plate (3) remote from the plenum chamber (9) wherein a plurality of mesas (15) are defined in those areas of the support plate surface intermediate the channels and a plurality of apertures (19) located in the channels (14) and each passing through the support plate (3), the apertures (19) extending between the support plate (3) and the plenum chamber (9).

### FIELD OF THE INVENTION

The present invention relates to apparatus used in the ARMACEL (Registered Trade Mark) process. That process basically involves partially or substantially completely encapsulating an article with a layer, or a plurality of layers, of thermoformable plastics material. In particular the present invention relates to a platen used to support such articles during their encapsulation. However, it will be appreciated that the present invention also finds application in vacuum forming and like processes.

### BACKGROUND OF THE INVENTION

The ARMACEL process and apparatus for forming structural articles, especially from weak substrates such as polystyrene and cardboard, and articles so formed, are disclosed in the applicant's International PCT Patent Application No. PCT/AU95/00100 entitled “A method and apparatus for forming structural articles” (WO 95/23682), International PCT Patent Application No. PCT/AU96/00541 entitled “Layered Structural Article” (WO 97/09166) and International PCT Patent Application No. PCT/AU00/00250 (WO 00/59709) entitled “An improved method of forming structural articles”—the contents of all three of which are hereby incorporated into the present specification by cross reference.

A further specification is that of International PCT Patent Application No. PCT/AU04/000826 lodged 24 Jun. 2004 and entitled “Method of, and Apparatus for, Forming an Article and an Article Formed thereby” discloses the encapsulation of an interior member which is neither at least partially fluid permeable nor is perforated to become so. The contents of this application is also hereby incorporated into the present specification by cross-reference.

By way of summary, the above patent applications disclose the forming of structural articles from a shape defining interior member and at least one external skin. The basic method of forming the structural articles comprises the following steps:

1. heating a thermoformable sheet intended to form the external skin;

2. bringing the heated sheet alongside the interior member;

3. applying a fluid pressure differential between opposite surfaces of the interior member and the sheet to conform the sheet to the shape of the interior member and mutually engage same; and

4. maintaining the fluid pressure differential until the sheet has cooled.

The application of a fluid pressure differential is normally brought about by evacuation of a gas (normally atmospheric air) between the heated sheet and the interior member or article. During this procedure the article sits on, and is supported by, a platen which is connected via a valved conduit to a vacuum tank or other source of reduced air pressure.

It is noted that significant differences exist between the ARMACEL and like processes and vacuum forming and like processes. In vacuum forming, for example, a sheet of plastics material is placed over a mould. The sheet is heated and sucked under vacuum to conform to the mound. The conformed sheet is then cooled and the vacuum removed to allow the conformed sheet to be taken away.

In order to achieve acceptable and uniform results in conforming the heated sheet to the shape of the interior member or article, it is desirable for the air to be evacuated as speedily as possible. The speed at which the air can be evacuated is influenced not only by the degree of vacuum (applied fluid pressure differential) but also by the nature of the platen.

### OBJECT OF THE INVENTION

It is therefore the object of the present invention to provide a platen which can be quickly and uniformly evacuated and assist in the ARMACEL process.

### SUMMARY OF THE INVENTION

In accordance with a first aspect of the present invention there is provided a platen for use in product encapsulation and like processes wherein said platen is configured to be gaseously evacuated, the platen comprising:

a base plate;

at least one gas evacuation conduit configured to communicate through the base plate;

a support plate spaced apart from the base plate to create a plenum chamber between the base plate and the support plate, each gas evacuation conduit in communication with the plenum chamber;

a first array of channels formed in a surface of the support plate remote from the plenum chamber wherein a plurality of mesas are defined in those areas of the support plate surface intermediate the channels; and

a plurality of apertures located in the channels and each passing through the support plate, the apertures extending between the support plate and the plenum chamber.

Preferably, predetermined channels intersect with one another and the apertures are located at the intersections of the channels. More preferably, the mesas have a second array of grooves formed in the support plate surface and leading into the channels wherein predetermined grooves intersect one with another. Preferably, the first and second arrays are substantially rectangular, hexagonal, octagonal or otherwise polygonal.

Preferably, the periphery of said support plate and the periphery of the base plate are configured to sealingly interengage. More preferably, the surface of the support plate remote from the plenum chamber includes a plurality of substantially parallel scratches.

In preferred embodiments, the support plate is spaced from the base plate by a plurality of spaced apart spacers, and each spacer is substantially cylindrical with its longitudinal axis extending substantially normal to the support plate.

Preferably, a fine mesh is supported by the mesas and a perforated sheet is supported by the fine mesh. More preferably, upper and lower ends of each aperture are tapered, radiussed or chamfered such that each aperture provides a venturi effect as gas passes therethrough.

Preferably, the platen further comprises a blocking plate having an edge seal disposed around its periphery, the blocking plate configured to block a predetermined number of the first array of channels and a predetermined number of the plurality of apertures to prohibit gaseous communication therethrough to the plenum chamber.

According to another aspect of the invention there is provided a method of providing a platen for use in product encapsulation and like processes wherein said platen is configured to be gaseously evacuated, the method comprising the steps of:

providing a base plate;

disposing at least one gas evacuation conduit through the base plate;

disposing a support plate adjacent the base plate to create a plenum chamber between the base plate and the support plate, the plenum chamber being in fluid communication with each gas evacuation conduit;

disposing a first array of channels in a surface of the support plate remote from the plenum chamber wherein those areas of the support plate surface intermediate the channels provide a plurality of mesas; and

disposing a plurality of spaced apart apertures through the support plate, the channels and the plenum chamber in fluid communication via the apertures.

Preferably, the method comprises the step of tapering, radiussing or chamfering upper and lower ends of each aperture such that each aperture provides a venturi effect as gas passes therethrough.

Preferably, the method comprises the step of sealingly interengaging the periphery of the support plate and the periphery of the base plate wherein, the volume within the sealed periphery defines the plenum chamber.

In preferred embodiments, the method comprises the step of disposing a blocking plate on the platen and over a predetermined number of the first array of channels and a predetermined number of the plurality of apertures to prohibit gaseous communication therethrough to the plenum chamber wherein the blocking plate has an edge seal disposed around its periphery.

It can therefore be seen that there is provided a platen for use in product encapsulation and like processes that can be quickly and uniformly evacuated assisting the results of the ARMACEL process. Furthermore, it can be seen that in cases where a delicate product is to be encapsulated, the rate of evacuation can be reduced to a preferred rate.

### BRIEF DESCRIPTION OF THE DRAWINGS

A preferred embodiment of the present invention will now be described with reference to the drawings in which:

FIG. 1 is an exploded perspective view of a platen according to the preferred embodiment;

FIG. 2 is a perspective view at an enlarged scale of a portion of the support plate shown encircled in FIG. 1;

FIG. 3 is a transverse cross sectional view through the assembled platen; and

FIG. 4 is an enlarged view of a portion of the platen as illustrated in FIG. 3.

### DETAILED DESCRIPTION

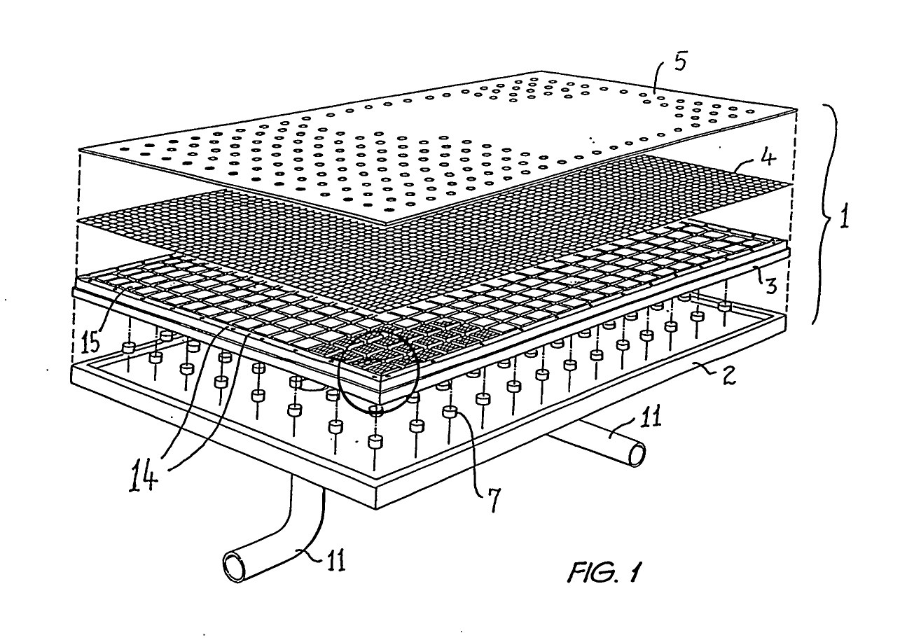

Referring to the drawings generally and FIG. 1 in particular, there is shown the platen 1 assembled from a stack of essentially co-planar plates or sheets. The lowermost of these plates is a base plate 2, next comes a support plate 3 which in turn supports a fine wire mesh 4 which in turn supports a perforated plate 5.

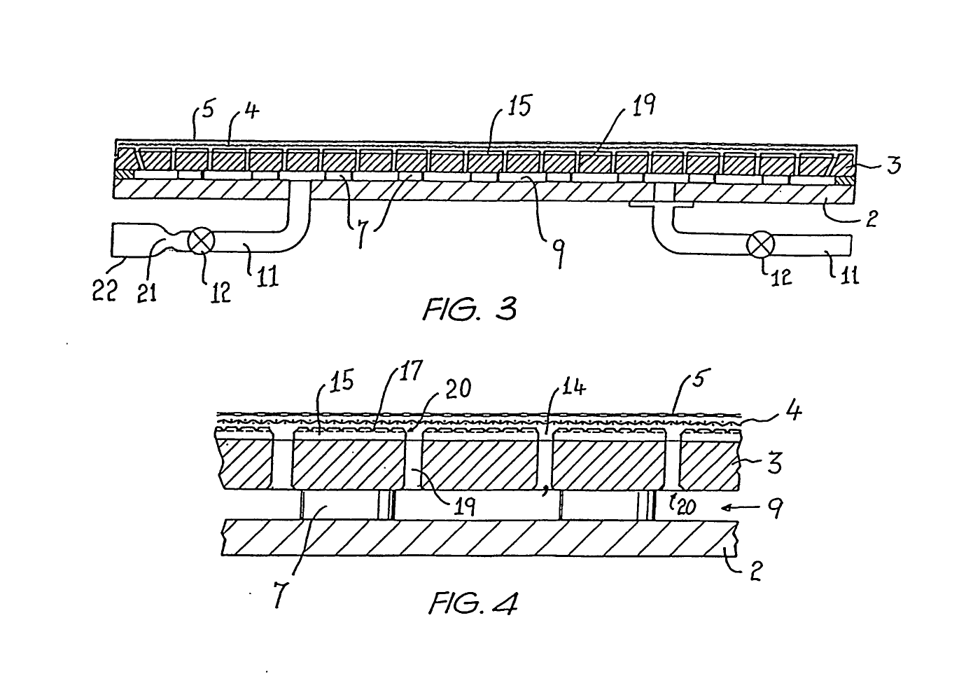

The support plate 3 is spaced from the base plate 2 by means of a regular array of spaced apart cylindrical spacers 7, as best shown in FIGS. 1 and 3. The volume created between the base plate 2 and support plate 3 defines a plenum chamber 9 which is sealed by inter-engagement of the peripheries of the plates 2 and 3.

A plural number, preferably three or four, of gas evacuation conduits 11 are disposed through the base plate 2 and are in fluid communication with the plenum chamber 9. Each of the conduits 11 is connectable to a vacuum tank or tanks (not illustrated) each conduit with a valve 12 disposed intermediate. In use, each conduit 11 is connected to the vacuum tank or tanks and valve 12 is actuated to allow gas to be evacuated from the plenum chamber 9.

As indicated on the left hand side of FIG. 3, some or all of the conduits 11 can pass through the base plate 2. Alternatively, as indicated on the right hand side of FIG. 3 the conduit 11 can terminate in a flange which overlies, and seals a through hole in the base plate 2.

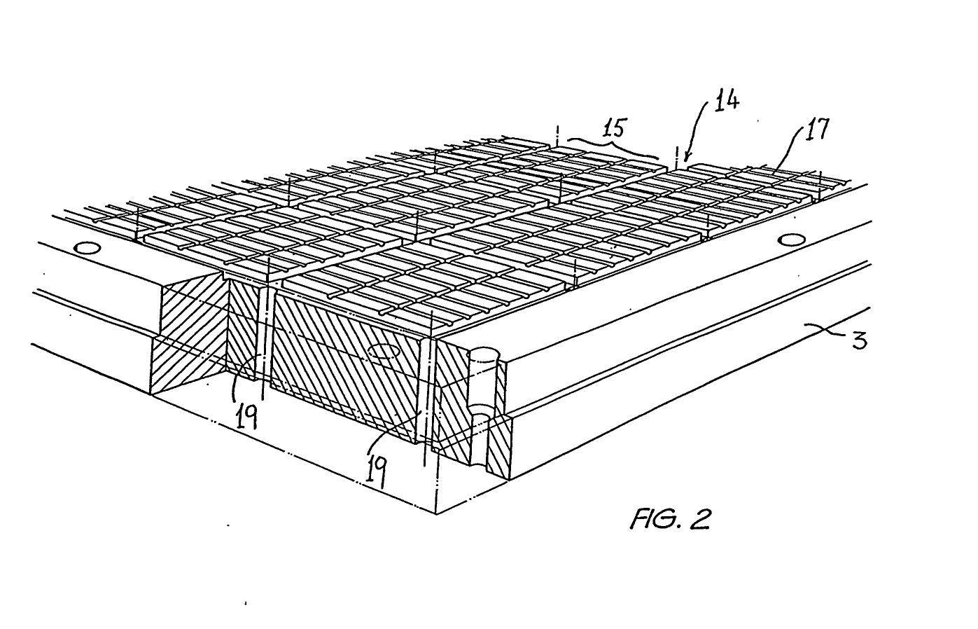

As best appreciated from FIG. 2, the upper surface of the support plate 3 is divided by means of a regular closely spaced rectangular array of channels 14 into a plurality of mesas 15. As best seen in FIG. 2, the top of each mesa 15 is in turn provided with a regular closely spaced rectangular array of grooves 17 which lead into the channels 14.

Apertures 19 are disposed at each intersection of the channels 14, the apertures passing through the support plate 3. The apertures 19 thus connect the channels 14 with the plenum chamber 9. The upper and lower ends of each aperture 19 are tapered, radiussed or chamfered as indicated at 20 in FIG. 4. The apertures ends 20 have the effect of creating a myriad of small venturis as gas passes through the apertures. Although not illustrated, it is noted that the aperture ends 20 can be tapered, radiussed or chamfered by any preferred amount or not at all.

A coarse sandpaper or other abrasive is used to create fine substantially parallel scratches in a direction parallel to the grooves 17 in the surface of the support plate 3 remote from the plenum chamber. After this sandpapering action the tops of the mesas 15 are then provided with a thin coat of lacquer.

As best seen in FIGS. 1 and 4, located above the mesas 15 is the wire mesh 4 and perforated plate 5 each of which is not essential to the air flow through the platen but which serve the useful function of preventing the heated thermoformable plastics sheet being sucked into the channels 14, grooves 17 and apertures 19. Furthermore, the mesh 4 and plate 5 serve to protect the support plate 3 from degradation through abrasion, wear and tear, and the like.

It will be appreciated by those skilled in the art that when an article (not illustrated) is placed on the platen 1 and the valves 12 are opened simultaneously, then air is evacuated from the plenum chamber 9 via the conduits 11. In particular, irrespective of the shape of the article or product located on the platen 1, air is able to escape from all around the article via the grooves 17 into the channels 14 and via the channels 14 through the apertures 19 and into the plenum chamber 9. The arrangement is such that a multiplicity of paths for the air are provided and so a quick and uniform evacuation results.

The platen 1 has been tested for its evacuation capability and compared both to those previously used for the ARMACEL process and also those commonly used in normal vacuum forming applications which do not involve the ARMACEL process. Both the speed of evacuation and the quality of the end product (ie the ARMACEL encapsulated article) were improved using the platen described in this specification.

It is thought that the improved performance results from many factors, including the fact that the shape, spacing and dimensions of the spacers 7 reduce the volume of the plenum chamber. The spacers 7 are relatively small and do not obstruct air flow within the plenum chamber, which air flow is thereby improved. In addition, the spacers 7 provide better, more uniform support to the support plate 3 and therefore reduce bending in the support plate 3 when the fluid pressure differential is applied.

Another factor is that this construction maximises and creates uniformity in the grooving of the top surface of the support plate 3. This allows for a uniform and maximum applied fluid pressure differential.

Referring again to the left hand side of FIG. 3 it is possible to locate a venturi 21 in some or all of the conduits 11. The venturi 21 can be located either downstream of the valve 12, or upstream of the valve 12 (not illustrated). The venturi 21 preferably leads into a large diameter conduit 22 which is connected to the vacuum tank(s) (not illustrated). It is thought that the venturi(s) 21 act to accelerate the air flow away from the platen 1 and thereby more quickly evacuate the plenum chamber 9 and enhance the overall performance.

To further improve the efficiency of the platen in use, it is noted that a predetermined number of channels 14 and a predetermined number of apertures 19 can be blocked off to prohibit gaseous communication therethrough to the plenum chamber. This can be achieved with, for example, an aluminium or other rigid blocking plate (not illustrated) having a flexible edge seal disposed around its periphery. Thus, by placing the blocking plate over a predetermined area of the surface of the support plate 2 remote from the plenum chamber 9 an effectively smaller area platen 1 is provided. Further, use of a metal such as aluminium for the blocking plate also serves to reflect heat back towards a thermoformable plastics sheet heater (not illustrated). The speed of evacuation of a smaller area can be advantageously quickened as a smaller volume needs to be evacuated. This also advantageously provides for a quicker drawing down of the thermoformable plastics sheet.

In addition, although the preferred material for the fabrication and support plate 3 is a timber composite material fabricated from sawdust and glue, other materials such as metals are also suitable. However, an advantage of the timber composite material (as opposed to, say, aluminium) is that it does not conduct heat well, nor does it expand or contract to any significant extent with changes in temperature. Conversely, the metal perforated plate 5 retains heat to some extent and thus the heated plastics film does not loose heat too quickly to adjacent objects. Similarly, the upper surface of the platen need not be flat but can instead be curved as illustrated in FIG. 13 of WO 97/09166.

The foregoing describes only one embodiment of the present invention and modifications, obvious to those skilled in the art, can be made thereto without departing from the scope of the present invention. For example, the array of channels 14 need not be a regular rectangular array as illustrated but could instead be provided by a regular hexagonal, octagonal or other polygonal array.

The term “comprising” (and its grammatical variations) as used herein is used in the inclusive sense of “having” or “including” and not in the exclusive sense of “consisting only of”.

1. A platen for use in product encapsulation and like processes wherein said platen is configured to be gaseously evacuated, said platen comprising:
a base plate;
at least one gas evacuation conduit configured to communicate through said base plate;
a support plate spaced apart from said base plate to create a plenum chamber between said base plate and said support plate, each gas evacuation conduit in communication with said plenum chamber;
a first array of channels formed in a surface of said support plate remote from said plenum chamber wherein a plurality of mesas are defined in those areas of said support plate surface intermediate said channels; and
a plurality of apertures located in said channels and each passing through said support plate, said apertures extending between said support plate and said plenum chamber.

2. A platen according to claim 1 wherein predetermined channels intersect with one another and said apertures are located at the intersections of said channels.

3. A platen according to claim 1 or 2 wherein said mesas have a second array of grooves formed in said support plate surface and leading into said channels.

4. A platen according to claim 3 wherein predetermined grooves intersect one with another.

5. A platen according to claim 4 wherein said second array is substantially rectangular, hexagonal, octagonal or otherwise substantially polygonal.

6. A platen according to any one of claims 1 to 5 wherein said first array is substantially rectangular, hexagonal, octagonal or otherwise substantially polygonal.

7. A platen according to any one of claims 1 to 6 wherein the periphery of said support plate and the periphery of said base plate are configured to sealingly interengage.

8. A platen according to any one of claims 1 to 7 wherein the surface of said support plate remote from said plenum chamber includes a plurality of substantially parallel scratches.

9. A platen according to claim 8 wherein said scratches are formed by sandpaper, emery board or other abrasive.

10. A platen according to any one of claims 1 to 9 wherein said support plate is spaced from said base plate by a plurality of spaced apart spacers.

11. A platen according to claim 10 wherein each said spacer is substantially cylindrical with its longitudinal axis extending substantially normal to said support plate.

12. A platen according to any one of claims 1 to 11 wherein a fine mesh is supported by said mesas.

13. A platen according to claim 12 wherein a perforated sheet is supported by said fine mesh.

14. A platen according to any one of claims 1 to 13 wherein upper and lower ends of each said aperture are tapered, radiussed or chamfered such that each aperture provides a venturi effect as gas passes therethrough.

15. A platen according to any one of claims 1 to 14 further comprising a blocking plate having an edge seal disposed around its periphery, the blocking plate configured to block a predetermined number of said first array of channels and a predetermined number of said plurality of apertures to prohibit gaseous communication therethrough to said plenum chamber.

16. A method of providing a platen for use in product encapsulation and like processes wherein said platen is configured to be gaseously evacuated, said method comprising the steps of:
providing a base plate;
disposing at least one gas evacuation conduit through said base plate;
disposing a support plate adjacent said base plate to create a plenum chamber between said base plate and said support plate, said plenum chamber being in fluid communication with each gas evacuation conduit;
disposing a first array of channels in a surface of said support plate remote from said plenum chamber wherein those areas of said support plate surface intermediate said channels provide a plurality of mesas; and
disposing a plurality of spaced apart apertures through said support plate, said channels and said plenum chamber in fluid communication via said apertures.

17. A method according to claim 16 wherein predetermined channels intersect with one another and said apertures are located at intersections of said channels.

18. A method according to claim 16 or 17 comprising the step of disposing a second array of grooves in said support plate surface, said second array of grooves leading into said channels.

19. A method according to claim 18 wherein predetermined grooves intersect one with another.

20. A method according to claim 19 wherein said second array is substantially rectangular, hexagonal, octagonal or otherwise substantially polygonal.

21. A method according to any one of claims 16 to 20 wherein said first array is substantially rectangular, hexagonal, octagonal or otherwise substantially polygonal.

22. A method according to any one of claims 16 to 21 comprising the step of sealingly interengaging the periphery of said support plate and the periphery of said base plate, the volume within said sealed periphery defining said plenum chamber.

23. A method according to any one of claims 16 to 22 further comprising the step of disposing a plurality of substantially parallel scratches on the surface of the support plate remote from the plenum chamber.

24. A method according to claim 23 wherein the scratches are made by sandpaper, emery board or other abrasive.

25. A method according to any one of claims 16 to 24 comprising the step of disposing a plurality of spacers in a spaced apart arrangement intermediate said support plate and said base plate.

26. A method according to claim 25 wherein each said spacer is substantially cylindrical and is disposed with its longitudinal axis extending substantially normal to said support plate.

27. A method according to any one of claims 16 to 26 comprising the step of disposing a mesh over said mesas to be supported thereby.

28. A method according to claim 27 comprising the step of disposing a perforated sheet over said mesh to be supported thereby.

29. A method according to any one of claims 16 to 28 comprising the step of tapering, radiussing or chamfering upper and lower ends of each said aperture such that each aperture provides a venturi effect as gas passes therethrough.

30. A method according to any one of claims 16 to 29 comprising the step of disposing a blocking plate on said platen and over a predetermined number of said first array of channels and a predetermined number of said plurality of apertures to prohibit gaseous communication therethrough to said plenum chamber wherein said blocking plate has an edge seal disposed around its periphery.
